(19) United States
(12) Patent Application Publication
(10) Pub. No.: US 2010/0186896 A1
(43) Pub. Date: Jul. 29, 2010

(54) Double facer in apparatus for manufacturing corrugated board and method of controlling heating of the double facer

(76) Inventors: Tadashi Itoyama, Hiroshima (JP); Hiroshi Ishibuchi, Hiroshima (JP); Kazukiyo Kono, Hiroshima (JP); Masashi Sasaki, Hiroshima (JP); Toshihide Kato, Hiroshima (JP); Toshinao Okihara, Hiroshima (JP)

Correspondence Address: WENDEROTH, LIND & PONACK, L.L.P., 1030 15th Street, N.W.,, Suite 400 East, Washington, DC, 20005-1503, US

(21) Appl. No.: 12/308,245

(22) PCT Filed: Feb. 5, 2008
(86) PCT No.: PCT/JP2008/052210

§ 371 Date: Apr. 21, 2009

(30) Foreign Application Priority Data
Feb. 19, 2007 (JP) 2007 038701

(51) Int. Cl. C09J 5/06; B32B 37/06

(52) U.S. Cl. 156/322; 156/359

(57) ABSTRACT

In a double facer in which a one-sided corrugated board and a liner sheet which are web-like and which are superposed with each other are glued to each other while they travels on a heating plate so as to produce a corrugated board, the heating plate has a thin wall thickness so as to enhance the efficiency of heat transfer to a paper sheet which travels on the upper surface of the heating plate, and the heating plate 20 is provided at the lower surface thereof with a heat radiation means (having the configuration that reinforcing ribs 22 are formed at the lower surface of the heating plate in a direction orthogonal to the direction of travel of a paper sheet, having their height which are successively decreased, or several steam through-holes 51 are formed in the heating plate, and are adapted to be fed therein with saturated steam whose pressure or temperature is successively lowered) in order to decrease a temperature difference between the upper surface and the lower surface of the heating plate so as to restrain warping of the heating plate within a tolerance, that is, the value of heat radiation from the upper surface of the heating plate to the one-sided corrugated board k and the liner sheet n is balanced with the heat radiation from the lower surface of the heating plate, thereby it is possible to restrain warping of the heating plate within a tolerance.

### TECHNICAL FIELD

The present invention relates to a double facer in a corrugated board manufacturing apparatus, which is so called as a corrugators, and in particular to a double facer incorporating a heating plate which has an enhanced heat transfer efficiency with respect to a paper sheet, and which is capable of preventing occurrence of thermal deformation of the heating plate that causes deterioration of the quality of a corrugated board.

### BACKGROUND ART

A production line including a corrugated board manufacturing apparatus comprises, in general, a mill roll stand for stacking paper rolls of paper materials such as front and back liner paper materials and a core paper material, a splicer serving as a paper splicing device for successively feeding materials of corrugated paper to a corrugators, a single facer for corrugating the core paper material paid out from the splicer and then gluing the same to the back liner material so as to produce a single-sided corrugated board, and a double facer gluing the one-sided corrugated board to the front liner material so as to produce a corrugated board.

Further, there are provided, on the production line downstream of the double facer, a slitter scorer for carrying out drawing of ruled lines on a corrugated board and cutting of the corrugated board at desired positions in the order of production of the corrugated board, and a cutoff unit for cutting the corrugated board, and there are provided, downstream of the cut-off unit, a removal mechanism for removing refuse paper which has come out in the paper splicer or on the production line downstream of the paper splicer.

Explanation will be made of a conventional double facer, as an example, with reference to FIG. 9. Referring to FIG. 9, a one-sided corrugated board K is preheated by a pre-heater 011, and is fed to a double facer 010 after coating a raw glue solution onto the corrugated tops of core paper c by means of a sizing unit 012. Meanwhile, front linter paper n is paid out from a paper material roll r mounted on a mill stand, and is fed to the double facer 010 after being preheated by a pre-heater 010.

The double facer 010 comprises a group of heating plates 014 which are horizontally arranged so as to define a horizontal heating surface, and on which the one-sided corrugated board k and the front liner paper n, being superposed with each other, travel. Each of the heating plates 014 has a steam chamber 021 into which steam for heating is fed, as shown in FIG. 10, by a suitable means, having an upper surface 021a which defines a heat radiation surface for the one-sided corrugated board k and the front liner paper n which are superposed with each other (as will be hereinbelow denoted “paper sheet”), the paper sheet receiving a heat from the upper surfaces 021a of the heating plates.

An upper belt conveyer 016 and a lower belt conveyer 017 are laid above the heating plates 014 and downstream of the same, respectively. A pressing unit 15 for pressing the one-sided corrugated board k and the front liner n by means of a pneumatically pressing unit, a roll or the like, from thereabove is provided on the rear surface side of the upper belt conveyer 016 above the heating plates 014.

There are arranged lower rolls 018 for supporting the lower conveyer 017 at the rear surface of the latter, and upper rolls 019 arranged at the rear surface of the upper belt conveyer 016, downstream of the pressing unit 015 and the heating plates 014, and accordingly, a paper sheet is clamped between the upper and lower belt conveyers 016, 017 so as to be conveyed while the paper sheet is pressed by the upper rolls 019.

The paper sheet which has been introduced between the heating plates 014 of the double facer 010 and the pressing unit 015 travels on the heating plates 014 while being pressed by the upper rolls 19 thereabove, and is therefore heated by the heating plates 014. Since the paper sheet is heated by the heating plates 014, the raw glue solution coated on the corrugated top of the core paper c of the one-sided corrugated board k is gelled, and accordingly, the one-sided corrugated board K and the front liner n are glued to each other by the adhesive strength thereof so that a corrugated board d is manufactured. It is noted that the paper sheet travels at a high speed, that is, for example, 300 m/min, and accordingly it passes over the running surface of the double facer in few seconds.

The thus manufactured corrugated board d is conveyed being clamped between the upper belt conveyer 016 and the lower belt conveyer 017 from thereabove and therebelow so as to be delivered into a next post-process station.

Heating steam fed into the steam chamber 021 of each of the heating plates 104, normally has a saturated steam pressure in a range from 1.0 to 1.3 MPa at a temperature in a range from 180 to 90 deg.C, and the adhesive strength of the paper sheet on the heating plates 014 is controlled by a supplied heat value and an applied pressure to the paper sheets, and should the supplied heat value or the applied pressure be insufficient, the adhesive strength would be lowered. On the contrary, should the supplied heat value or the applied pressure be excessively high, the quality of a corrugated board would be lowered due to collapse of the corrugation or the like.

By the way, the heating plates 014 has to have a width corresponding to a maximum width of the paper sheet to be fed thereon, which is therefore in general from 1,900 to 2,600 mm. Further, in order to uniformly heat the paper sheet, it has to have a flatness with a high degree accuracy (not less than 0.1 mm). Further, it is required to have a strength withstanding the pressure (1.0 to 1.3 MPa) of steam fed into the steam chamber 021, and accordingly, it has to have a partition wall (rigid) having a wall thickness of about 30 mm. Thus, its heat conductivity is unsatisfactory with respect to the paper sheet. For making compensation therefor, the conventional heating plates have a structure having an extremely large heat capacity, that is, it is formed from a cast iron having a wall thickness of about 150 mm.

Thus, the conventional heating plate has offered the problem that it is lower responsive with respect to a demand for abruptly raising or lowering the temperature thereof caused by a rapid change in a gluing speed or in the kind of paper constituting the paper sheet. Thus, there would be caused such a situation that the glued parts of the single-sided corrugated board k and the liner sheet n are excessively dry or undried, resulting in occurrence of inferior gluing such as false gluing, occurrence of warping of a corrugated board after completion of the production thereof. Further, if the responsiveness is low, the speed of travel of the paper sheets cannot be increased, and accordingly, the productivity thereof cannot be enhanced.

Thus, the adjustment to the temperature of heating the paper sheet is carried out in the way that the applied pressure of the pressurizing unit 051 is changed with respect to the paper sheet so as to adjust the thermal contact conductivity between the upper surface of the heating plate and the paper sheet. It is noted that the temperature of the corrugated board d is set in general to a value in a range from 70 to 140 deg.C. in the outlet portion of the double facer.

However, it is difficult to apply a uniform pressure to the paper sheet over the width of the latter, due to an affection caused by a widthwise warp of the components constituting the pressurizing unit 015. The widthwise ununiformity of the applied pressure causes the ununiformity of temperature widthwise of the paper sheets, resulting in warping of the paper sheets, and accordingly, there would be caused a problem of lowering the quality of a corrugated board as a product.

Thus, in order to cope with the above-mentioned problem, a Patent Document 1 (The specification and the accompanying drawings of Japanese Patent Laid-Open No. H02-48329) discloses a structure of the heating plate in which several heating medium supply holes are formed in parallel in a thick plate, thicknesswise thereof so as to aim at thinning the partition wall measured from the heating medium supply holes to the paper sheet traveling surface so as to enhance and uniform the efficiency of heat dissipation to the paper sheet traveling surface and as well to facilitate the adjustment to heating. FIG. 5 shows a structure of the heating plate formed with a plurality of reinforcing ribs at the lower surface side of its thick plate.

Further, a Patent Document 2 (U.S. Pat. No. 5,662,765) discloses a structure of a heating plate having a thinned wall thickness of, for example, from 20 to 50 mm, and formed with several steam holes which are arrayed in parallel. By thinning the heating plate as stated above, the thermal responsiveness can be increased, and as well the heating plate and the members which support the heating plate are thermally isolated from each other so as to allow the upper and lower surface of the heating plate to come under a thermally identical condition in order to prevent the heating plate from warping

Patent Document 1 discloses a heating plate having a thin wall thickness so as to increase the thermal radiation efficiency with respect to the paper sheet in order to enhance the temperature responsiveness of the heating plate. However, since the heat of the heating plate is radiated to the paper sheet travelling on the upper surface of the heating plate, the values of heat radiation from the upper and lower surfaces of the heating plate are different from each other, and accordingly, as the heating plate is thinned, the heating plate is likely to be deformed due to a temperature difference between the upper and lower surfaces of the heating plate. The deformation of the heating plate would possibly cause a corrugated board as a manufactured product to be deformed along the surface of the heating plate, resulting in lowering of its quality. However, Patent Document 1 fails to disclose measures for solving the above-mentioned problems.

Further, Japanese Patent Document 2 discloses measures for preventing a heating plate from warping in the manner that the wall of the heating plate is thinned, and the heating plate and the members for supporting the heating plate are thermally isolated from each other so as to subject the upper and lower surfaces of the heating plate to an identical thermal condition. However, as stated above, the upper surface of the heating plate is made into contact with a paper sheet which therefore absorbs a heat from the upper surface of the heating plate, and accordingly, it is impossible to subject both upper and lower surfaces of the heating plate to one and the same thermal condition even though only the heating plate is thermally isolated from the support members. Thus, the measures disclosed in Patent Document 2 cannot completely eliminate the problem of thermal deformation of the heating plate.

### DISCLOSURE OF THE INVENTION

The present invention is devised in view of the above-mentioned problems inherent to the prior art, and accordingly, an object of the present invention is to provide a method in which a heating plate has a thin wall thickness so as to enhance the efficiency of heat radiation with respect to a paper sheet which travels on the upper surface of the heating plate and as well to enhance the responsiveness with respect to a set temperature while decreasing the temperature difference between a contact surface (upper surface) and an opposite surface (lower surface) of the heating plate so as to constrain the thermal deformation of the heating plate within an allowable range in order to prevent a corrugated board from warping in a vertical direction caused by the thermal deformation of the heating plate.

To the end, according to the present invention, there is provided a method of heating a double facer, in which a one-sided corrugated board and a liner sheet which are web-like are fed on a heating plate, being superposed with each other so as to be glued to each other in order to produce a corrugated board, wherein a heat radiation means is provided at the lower surface of the heating plate for balancing the value of heat radiation to the one-sided corrugated board and the liner sheet on the upper surface of the heating plate, with the value of heat radiation from the lower surface of the heating plate. Thereby it is possible to constrain warping in the vertical direction within an allowable range.

In the method according to the present invention, with the provision of the radiation means arranged at the lower surface of the heating plate in view of the value of heat radiation from the upper surface of the heating plate to the paper sheet, the value of heat radiation from the upper surface of the heating plate is balanced with the value of heat radiation from the upper surface of the heating element. Thus, the temperature difference between the upper and lower surfaces of the heating plate is decreased, thereby it is possible to prevent the heating plate from being thermally deformed, that is, to prevent occurrence of warping of the heating plate in the vertical direction.

The paper sheet in which the one-sided corrugated board is superposed with the liner sheet one upon another and which is introduced into the double facer has a lowest temperature in the inlet portion of the double facer, and then, receives a heat from the upper surface of the heating plate while it travels on the upper surface of the heating plate so as to have a highest temperature in the outlet portion of the heating plate. Accordingly, if the temperature of the heating plate is set to be uniform from the inlet portion to the outlet portion thereof, the temperature difference between the paper sheet and the heating plate becomes maximum in the inlet portion of the heating plate and becomes minimum in the outlet portion thereof, that is, the value of heat radiation from the upper surface of the heating plate has such a gradient that the value of heat radiation is decreased toward the outlet portion of the heating plate from the inlet portion thereof in which the value of heat radiation is maximum.

Accordingly, in the method according to the present invention, the value of heat radiation from the lower surface of the heating plate by the above-mentioned heat radiation means is set in accordance with the value of heat radiation from the upper surface of the heating plate so as to have the decreasing gradient that the value of heat radiation is decreased, from the inlet portion of the heating plate to the outlet portion thereof, and accordingly, the heat radiations from the upper and lower surfaces of the heating plates are balanced with each other. Thus, the temperature difference between the upper and lower surfaces of the heating plate can be decreased, thereby it is possible to prevent the heating plate from warping.

In this case, the heating plate is formed so as to be planar, and is formed therein with several steam through-holes in parallel in the direction crossing (preferably orthogonal to) the direction of travel of the paper sheet, and steam is fed through the steam through-holes, thereby it is possible to enhance the heat transfer coefficient for the paper sheet traveling on the upper surface of the heating plate and as well to enhance the responsiveness to a demand for changing the set temperature.

Incidentally, it is required to gelatinize (gelling) glue applied to the corrugated top parts of the one-sided corrugated board so as to allow the one-sided corrugated board and the front liner sheet to be satisfactorily glued to each other while the paper sheet travels on the heating plate. Since the paper sheet travels at a high speed, it would be preferable to set the decreasing gradient of heat radiation in such a manner that the temperature of the heating plate is higher in the inlet portion of the double facer, and is decreased from the inlet portion to the outlet portion of the heating plate so as to ensure the gelatinization of the glue, although it depends upon a kind of a paper sheet.

In the method according to the present invention, with the provision of the configuration that the several steam through-holes are formed in parallel in the planar heating plate in the direction crossing (preferably orthogonal to) the direction of travel of the paper sheet, as the means for setting the temperature gradient that the temperature is lowered from the inlet portion to the outlet portion of the heating plate, saturated steam can be fed into the steam through-holes which are arranged in parallel, from a steam supply pipe line by way of pressure reducing valves so that the pressure of the saturated steam fed to the steam through-holes is successively reduced from the inlet portion to the outlet portion of the heating plate, at unit intervals such as for every steam through-hole or for every group of the steam through-holes.

With this configuration, by using each of the pressure reducing valves for each of the steam through holes formed in parallel or for each of groups of the steam through-holes, without the necessity of the provision of a plurality of steam supply sources, the above-mentioned temperature gradient can be materialized by using a single steam supply source with a simple pipe line arrangement.

It is required to change the value of heat fed from the heating plate to the paper sheet in accordance with a kind (basis weight) of the paper sheet or a speed of travel of the paper sheet. Conventionally, since the value of heat fed from the heating plate has been set in view of a gluing condition of a thick paper sheet at a high speed, there has been caused such a disadvantage that the heat value becomes excessive in the case of gluing a thin sheet, resulting in excessive dryness, and accordingly, the thin paper sheet warps and so forth. However, with the provision of the above-mentioned configuration, the pressure of the steam to be fed can be changed, depending upon a kind of paper sheet or a speed of travel of the paper sheet, thereby it is possible to prevent the heat value from being excessive during gluing of a thin paper sheet at a low speed.

Further, according to a first aspect of the present invention for carrying out the above-mentioned method according to the present invention, there is provided a double facer in which a one-sided corrugated board and a liner sheet which are web-like are superposed and glued to each other while they travel on a heating plate, for producing a corrugated board, wherein the heating plate is formed so as to be planar, and several steam through-holes are formed in parallel in a direction crossing (preferably orthogonal to) the direction of travel of the paper sheet while the heating plate is provided with a heat radiation means in which reinforcing ribs (rib-like heat radiation parts) are formed at the lower surface thereof (being made of a material identical with that of the heating plate or the material having a grade higher than tat of the material of the heating plate) and are projected therefrom so as to enlarge the heat radiation area, in order to balance the value of heat radiation to the one-sided corrugated board and the line sheet from the upper surfaced of the heating plate with the value of heat radiation from the lower surface of the heating plate.

According to the first aspect of the present invention, there is provided a heating plate which is formed in a planar shape, and which is formed with several steam through-holes in parallel in the direction crossing (preferably orthogonal to) the direction of travel of a paper sheet. With this configuration, the necessity of a pressure container for reserving high pressure steam can be eliminated, and the partition wall in which the steam through-holes are formed can have a thinned thickness. Thus, the thickness of the heating plate itself can be decreased. However, since the heating plate is thinned, the heating plate possibly causes warping. Accordingly, in the present invention, with the provision of reinforcing ribs, it is possible to aim at preventing the heating plate from warping, and as well, at enlarging the heat radiation area in order to cause natural convection in the heightwise direction of the reinforcing ribs so as to carry out heat radiation. By balancing the value of heat radiation caused by contact heat transfer between the upper surface of the heating plate and the paper sheet with the value of heat radiation caused by the natural convention at the lower surface of the heating plate, the temperature difference between the upper and lower surfaces of the heating plate is decreased, thereby it is possible to prevent the heating plate from being deformed.

In the first aspect of the present invention, the several reinforcing ribs may be arranged in both direction of travel of a paper sheet and direction crossing (for example, orthogonal to) the direction of travel of paper sheet, being spaced from one another (in grid-like or rhombic-like combination) so as to form several lattices. Alternatively, the several reinforcing ribs may be arranged in parallel, being spaced from one another in the direction crossing (orthogonal to) the direction of travel of a paper sheet.

With the former configuration, since the reinforcing ribs are formed in a grid-like configuration, the heat radiation area can be enhanced, and accordingly, the capacity of heat radiation can be enhanced. Further, since the reinforcing ribs are arranged in both direction of travel of a paper sheet and direction crossing (orthogonal to) the direction of travel of a paper sheet, the reinforcing ribs can exhibit the technical effects and advantages that the heating plate can be restrained from being thermally deformed in both direction of travel of a paper sheet and direction crossing (orthogonal to) the direction of travel of a paper sheet. Thus, a corrugated board as a product can be prevented from warping in both direction of travel of a paper sheet and direction crossing (orthogonal to) the direction of travel of a paper sheet, thereby it is possible to allow the paper sheet to travel at a high speed and to produce a corrugated board having a high quality.

Meanwhile, with the latter configuration, the corrugated board can be prevented from warping in the direction crossing (orthogonal to) the direction of travel of a paper sheet, and further, the configuration of the reinforcing ribs can be simplified, thereby it is possible to reduce the costs required for machining and welding during a manufacture of the heating plate. Since the plurality of heating plates are arranged in parallel along the direction of travel of a paper sheet, the thermal deformation of the respective heating plates in the direction of travel does not so much affect the quality of the corrugated board in comparison with the warping of the heating plates in the direction crossing (orthogonal to) the direction of travel of a paper sheet. Thus, the latter configuration can be applied to the manufacture of a corrugated board in which microscopic warping can be ignored in the direction of travel of a paper sheet.

Further, as stated above, the value of heat radiation from the upper surface of the heating plate has a gradient in which the value of heat radiation is decreased (stepped-likely), from the inlet portion to the outlet portion of the heating plate. In view of the value of heat radiation from the upper surface of the heating plate, the height of the reinforcing ribs is gradually decreased in the direction from the inlet portion to the outlet portion of the heating plate, thereby it is possible to have the gradient that the temperature of saturated steam is continuously lowered from the inlet portion to the outlet portion of the heating plate, and as well to balance the value of heat radiation at the lower surface of the heating plate with the value of heat radiation at the upper surface of the heating plate. In this case, the plurality of heating plates arranged in the double facer along the direction of travel of a paper sheet are divided into, for example, three to four groups, and the projecting height of the reinforcing ribs of the heating plates in the upstream side first group in which the value of heat supply to the paper sheet is large is set to be highest while the projecting height of the reinforcing ribs is successively decreased in the order of the second, third groups toward the downstream side, so as to allow the temperature of saturated steam to have a gradient with which the temperature is step-likely decreased from the inlet portion to the outlet portion of the heating plate.

Further, the saturated steam is fed into the steam through-holes from a steam supply pipe line through pressure reducing valves so as to allow the saturated steam fed to the steam through-holes to have the gradient that the pressure of the saturated steam is decreased, from the inlet portion to the outlet portion of the heating plate, thereby it is possible to allow the temperature of the saturated steam to have the gradient that the temperature is lowered from the inlet portion to the outlet portion of the heating plate.

Further, in the first aspect of the present invention, the steam through-holes may be connected in parallel to the steam supply pipe line so as to feed the steam into the steam through-holes in one and the same direction, or the steam supply pipe line may be connected to the steam through-hole at the most upstream side as viewed in the direction of travel of the paper sheet while the steam through-holes are connected in series to one another by U-like communication pipes outside of the heating plate.

In the former configuration in which the steam is fed into the respective steam through-holes in one and the same direction, the steam having a uniform temperature can be fed to the heating plates arranged in the direction of travel of a paper sheet. Accordingly, the heating temperatures of the heating plates can be uniform along the direction of travel of a paper sheet.

In the latter configuration in which the steam flows from the upstream side to the downstream side of the heating plate within the heating plate in the direction of travel of a paper sheet, the paper sheet can absorb a large amount of heat from the high temperature steam in the inlet portion of the heating plate, and as well, the temperature of the saturated steam can have a gradient with which the temperature is step-likely decreased from the inlet portion to the outlet portion of the heating plate. Thus, the gelatinization of glue can be promoted, thereby it is possible to obtain a satisfactory adhesive strength. No branch pipes branching from the steam supply pipe line and connected to the steam through-holes are required, thereby it is possible to exhibit the advantage that the arrangement of the steam pipe lines can be simplified.

According to a second aspect of the present invention, there is provided a double facer causing a one-sided corrugated board and a paper liner which are web-like and which are superposed with each other to travel on a heating plate so as to glue them each other in order to produce a corrugated board, wherein the heating plate is formed in a planar shape, and several steam through-holes are formed in the heating plate in parallel in a direction crossing (preferably orthogonal to) the direction of travel of a paper sheet, the wall thickness of the heating plate on the lower side of the steam through-holes is set to be larger than that upper side of the steam through-holes so as to balance the value of heat radiation to the one-sided corrugated board and the paper liner from the upper surface of the heating plate with the value of heat radiation from the lower surface of the heating plate. This configuration does not require any special heat radiation means. It is only required to make the wall thicknesses measured from the steam-through holes to the upper and lower surfaces of the heating plate different from each other. That is, by setting the wall thickness measured from the steam through-holes to the lower surface of the heating plate to a larger value, the temperature difference between the steam through-holes and the lower surface of the heating plate becomes larger. Thus, the temperature difference between the upper surface and the lower surface of the heating plate can be decreased during the travel of the paper sheet, thereby it is possible to reduce the degree of thermal deformation caused by the temperature difference.

With the apparatus according to the second aspect of the present invention in which no reinforcing ribs for restraining the thermal deformation are provided, the machining of the heating plate can be simplified. It is noted that the value of heat radiation from the upper surface of the heating plate varies, depending upon a traveling speed or a kind (basis weight) of the paper sheet, and accordingly, the wall thickness from the steam through-holes to the lower surface of the heating plate is suitably set in accordance with a traveling speed or a kind (basis weight) of the paper sheet.

The tolerance limit of warping of the heating plate in the double facer on operation is usually ±0.3 mm. In order to restrain the warping of the heating plate within this tolerance limit, it is sufficient to set the temperature difference between the upper and lower surfaces of the heating plate to be not higher than 1.5 deg.C. With the apparatus according to the first aspect of the present invention and the apparatus according to the second aspect of the present invention, the temperature difference between the upper and lower surfaces of the heating plate can be restrained below 1.5 deg.C.

With the method according to the present invention in which the heat radiation means is provided at the lower surface of the heating plate so as to balance the value of heat radiation from the upper surface of the heating plate to the one-sided corrugated board and the liner sheet, with the value of heat variation from the lower surface of the heating plate, it is possible to restrain the warping of the heating plate below the tolerance limit. Thus, a corrugated board as a product can be prevented from warping, thereby it is possible to produce a high quality corrugated board.

Further, with the apparatus according to the first and second aspect of the present invention in which the heating plate is formed in a planar shape and is formed therein with the several steam through-holes in parallel in the direction crossing (preferably orthogonal to) the direction of travel of a paper sheet, the heating plate can have a thin wall, thereby it is possible to reduce the temperature difference between the steam through-holes and the upper surface of the heating plate so as to apply a larger heat value per unit area to the paper sheet. Accordingly, the heat value during a high speed travel of a thick paper sheet can be prevented from being insufficient, thereby it is possible to enhance the upper limit of the gluing speed in comparison with the conventional one. Further, since the heating plate can be thinned, the response speed required for changing the set temperature can be enhanced.

Further, due to the effect of the reinforcing ribs formed at the lower surface of the heating plate in the apparatus according to the first aspect of the present invention, and due to the difference between the thickness measured from the steam through-holes to the upper surface of the heating plate and the thickness measured therefrom to the lower surfaces of the heating plate in the second aspect of the present invention, the values of heat radiation from the upper and lower surfaces of the heating plate can be balanced so as to decrease the temperature difference between the upper and lower surfaces of the heating plate, thereby it is possible to prevent the heating plate from being thermally deformed during a travel of a paper sheet.

### BRIEF DESCRIPTION OF THE DRAWINGS

FIG. 1 shows a heating element in a first embodiment of the present invention in which (a) is a perspective view, (b) is a bottom view and (c) is a sectional view along line A-A in (a);

FIG. 2 shows a heating plate in a second embodiment of the present invention, in which (a) is a perspective view illustrating the heating plate, (b) is a chart which shows a temperature curve of a paper sheet on the heating plate;

FIG. 3 is a configuration view illustrating a double facer body in a third embodiment of the present invention;

FIG. 4 shows a heating plate in the double facer shown in FIG. 3, in which (a) is a sectional view along line A-A in FIG. 3, (b) is a sectional view along line C-C in FIG. 3, (c) is a sectional view along line D-D in FIG. 3, and (d) is a chart which shows temperature curves of the heating plate and a paper sheet on the heating plate;

FIG. 5 is a perspective view illustrating a heating plate in a forth embodiment of the present invention;

FIG. 6 is a plan view for explaining a variant form of the fourth embodiment;

FIG. 7 shows a fifth embodiment of the present invention in which (a) is a perspective view, and (b) is a bottom view;

FIG. 8 shows a heating plate in a sixth embodiment of the present invention in which (a) is a perspective view and (b) is an enlarged elevation view;

FIG. 9 is a systematic view illustrating a conventional double facer; and

FIG. 10 is a sectional view illustrating a conventional heating plate.

### BEST MODE FOR CARRYING OUT THE INVENTION

Explanation will be made the present invention with the use of embodiments shown in the accompanying drawings. It is noted here that the dimensions, materials, shapes and the relative positions of the components described in the embodiments should not be intended to limit the present invention thereto unless otherwise specified.

### Embodiment 1

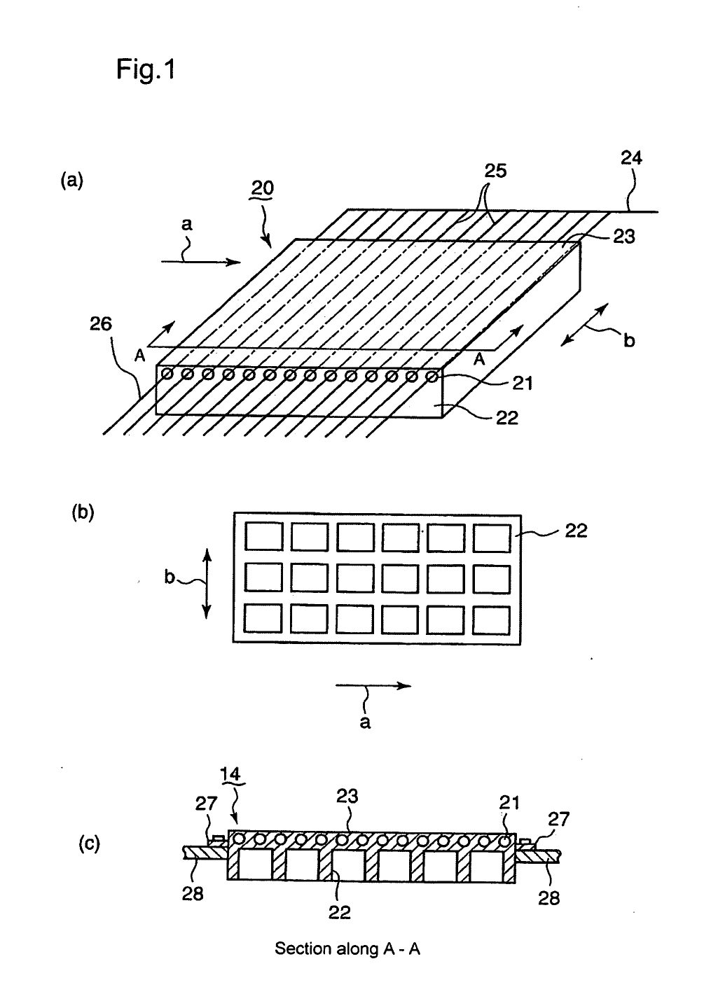

Explanation will be made of a first embodiment of the present invention with reference to FIG. 1 which shows a heating plate 20 that is used in a double facer and in which (a) is a perspective view, (b) is a bottom view and (c) is a sectional view along line A-A in (a). Referring to FIG. 1, the heating plate 20 has a thin plate-like shape having a thickness of about 50 mm and made of a metal material such as SS, SUS or FCD. They exhibit such advantages that SS has a satisfactory heat transfer coefficient, and SS and SUS are weldable while SUS is rust-resistant.

The thin-plate part is formed therein with several steam through-holes 21 which are arrayed in parallel with a widthwise direction b of a paper sheet, orthogonal to a direction a of travel of the paper sheet. The steam through-holes 21 have a bore diameter of, for example, about 30 mm, and are communicated at their one end with branch pipes 25 branching in parallel from a steam supply pipe line 24 connected to a steam supply source which is not shown, and are connected at the other end with a steam discharge pipe line by way of branch pipes 26 on the steam discharge side.

The heating plate 20 is formed with reinforcing ribs 22 projected downward from the bottom part thereof. The reinforcing ribs 22 are spaced from one another in both direction a of travel of the paper sheet and direction b of the widthwise of the paper sheet so as to define several lattices. The length of the reinforcing ribs 22 is uniform. The heating plate 20 has a length of 1,900 to 2,600 mm in the widthwise b of a paper sheet, and is also formed with several lattices each having one side whose length is, for example, about 800 mm in the direction a of travel of a paper sheet. A plurality of heating plates 20 having a configuration as stated above are arranged in the direction a of travel of a paper sheet. Further, the length of the reinforcing ribs is suitably set to depending upon a heat radiation value at the upper surface of the heating plate, for example, about 100 mm and the width thereof is set to about 10 to 40 mm.

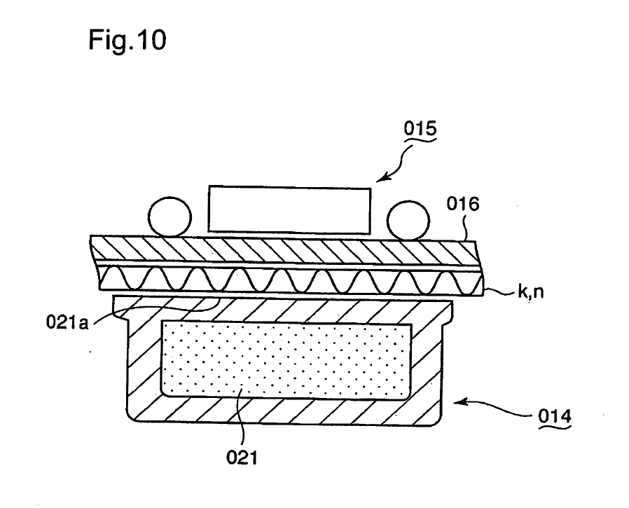

With this configuration, saturated steam is fed into the steam through-holes 21 from the steam supply source by way of the steam supply pipe line 24 and branch pipes 25. By feeding the saturated steam into the steam through-holes 21, the heating plate 20 is heated up to a predetermined temperature. As stated above, the saturated steam is fed into the steam through-holes 21 under a normal pressure of 1.0 to 1.3 MPa at a temperature from 180 to 190 deg.C. The paper sheet (which is composed of the one-sided corrugated board k and a liner sheet n superposed one upon another as shown in FIGS. 9 and 10) which travels in the direction of the arrow a, making contact with an upper surface 23 of the heating plate 20 is heated up, and is pressed by a pressing unit (a pressing unit 015 shown in FIG. 9). Thus, the paper sheet is glued in a gluing station, and accordingly, a corrugated board d is completed.

It is noted that the heating plate 20 is provided with support brackets 27 projected from opposite sides part thereof as shown in FIG. 1(c), and the support brackets 27 are attached to main frames 28 of the double facer, which are arranged on opposite sides of the heating plate 20. Thus, a space with no members therein is defined below the heating plate 20, and accordingly air convection is possibly caused.

With the configuration of this embodiment, the heating plate 20 is formed as a thin-wall plate so as to decrease the temperature difference between the inner surface of each of the steam through-holes and the upper surface 23 of the heating plate with which the paper sheet makes contact, and accordingly, the heat can be applied to the paper sheet by a large value per unit area. Further, as the steam through-holes 21 have the type that pierces through the heating plate 20, and the drilling thereof can be easily made. Thus, no condensed water remains in the steam through-holes, and accordingly, the heat transfer efficiency can be enhanced by the condensing latent heat of the steam, in comparison with the conventional type that the steam is reserved in a container.

Thus, insufficient heat during a high speed travel of the paper sheet is eliminated, and accordingly, the upper limit of the gluing speed can be enhanced. Further, since it is possible to form the heating plate 20 into the thin-wall plate, the responsive speed required for changing the set speed can be enhanced by two to three times higher than that of the conventional heating plate 014 as shown in FIG. 10.

Further, with the provision of the reinforcing ribs 22 in the lower part of the heating plate, the area of heat radiation from the lower part of the heating plate is enlarged, and the amount of the heat radiation is increased due to heat convective transfer of air flowing vertically along the reinforcing ribs 22. Further, the temperature difference between the upper surface of the heating element with which the paper sheet makes contact, and the lower surface thereof can be decreased, and accordingly, the thermal warping of the paper sheet upon the travel on the heating plate can be reduced in comparison with a configuration with no reinforcing ribs 22. Thereby it is possible to reduce the warping of the corrugated board caused by the thermal warping of the heating plate 20.

Further, since the reinforcing ribs 22 are formed in a grid-like shape having lengthwise sides which are in the direction a of travel of a paper sheet and the widthwise sides which are in the direction b widthwise of the paper sheet, the warping of the heating plate 20 can be further reduced in both direction a of travel of a paper sheet and direction b widthwise of the paper sheet. As stated above, although a tolerance limit value of warping in the direction b widthwise of the paper sheet in the double facer is ±0.3 mm, the warping of the heating plate according to this embodiment can be sufficiently restrained below the tolerance limit value.

Further, in this embodiment, by allowing steam to flow through the steam through-holes 21 in one and the same direction, steam having a uniform temperature along the direction a of travel of a paper sheet can be fed into the heating plate 20. Thus, the heating temperature of the heating plate 20 can become uniform along the direction a of travel of a paper sheet.

### Embodiment 2

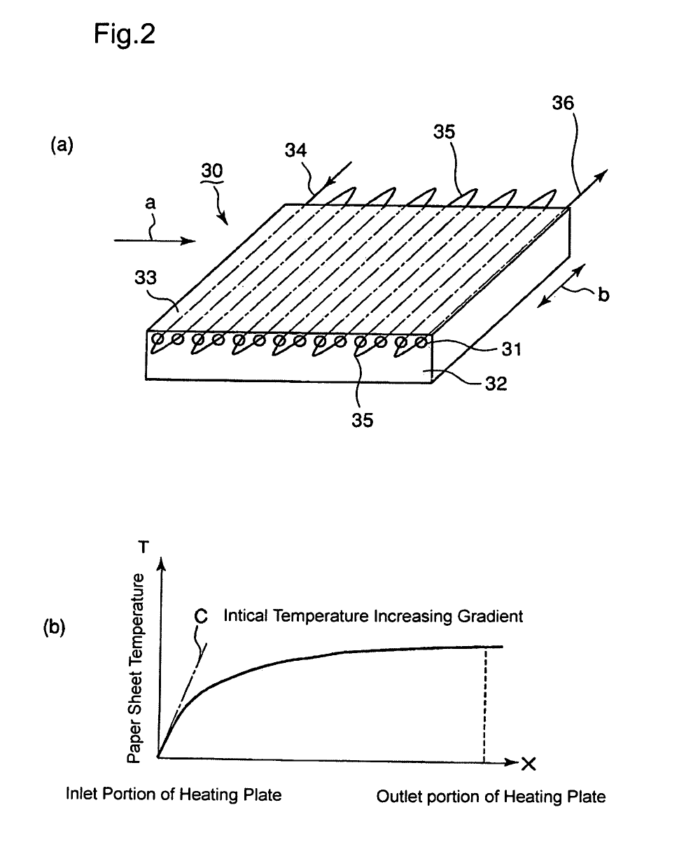

Next, explanation will be made of a second embodiment of the present invention with reference to FIG. 2. (a) in FIG. 2 is a perspective view which shows a heating plate in this embodiment, and (b) is a chart which shows a temperature increasing curve of a paper sheet when the paper sheet travels from the inlet portion to the outlet portion of the heating plate. In (a) in FIG. 2, the configurations of steam through-holes 31 and the reinforcing ribs 32 are the same as those in the first embodiment. A steam supply pipe line 34 is connected to the steam though-hole 31 at the most upstream side in the direction a of travel of a paper sheet, and the steam through-holes 31 are connected to one another via the intermediary of U-like pipes 35 outside of the heating plate 30, that is, the steam through-holes 31 are connected in series. It is noted that flexible hoses may be used as the U-like pipes 35. Steam is fed into the steam through-holes 31 so as to heat the heating plate 30, and is discharged by way of a steam discharge pipe line 36.

As shown in (b) in FIG. 2, the temperature increasing curve of the paper sheet exhibits a maximum temperature increasing gradient C in the inlet portion of the heating plate so as to promote the gelatinization of glue, thereby it is possible to obtain satisfactory adhesiveness. In this embodiment, the steam is fed into the steam through-hole 31 at the most upstream side in the direction a of travel of the paper sheet, and the steam is adapted to flow from the upstream side to the lower stream side (the inlet portion to the outlet portion of the heating plate 30) in the direction a of travel of the paper sheet within the heating plate 30. Accordingly, the paper sheet can absorb a large amount of heat in the inlet portion of the heating plate 30, from high temperature steam, the gelatinization of glue can be promoted, thereby it is possible to obtain satisfactory gluing.

Further, it is possible to eliminate the use of branch pipes, a header and the like for connecting the steam supply pipe line 34 to the steam through-holes 31, and accordingly, the configuration of the steam pipe line can be simplified. Further, the technical effects and advantages obtained by the heating plate 30 which is thinned, and the technical effects and advantages obtained by the reinforcing ribs 32 are similar to those of the first embodiment.

### Embodiment 3

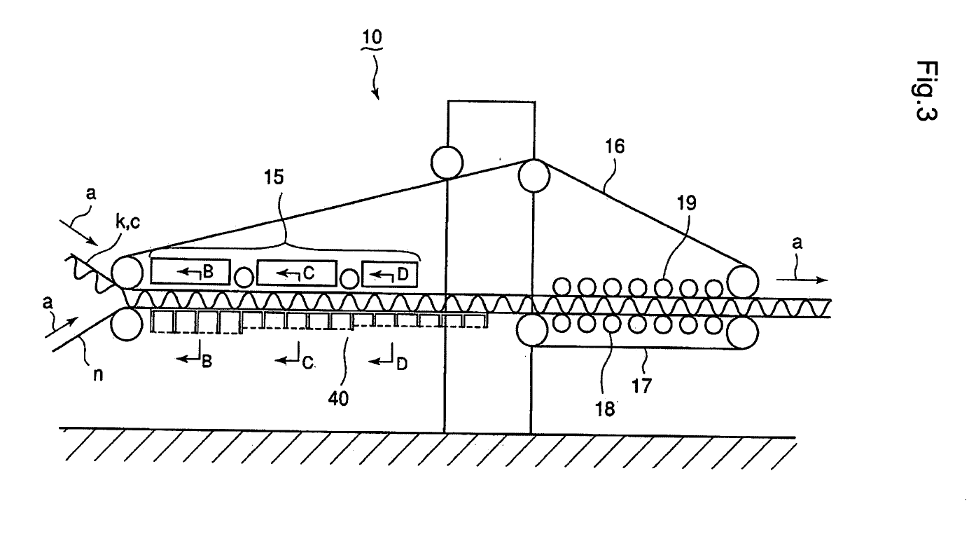

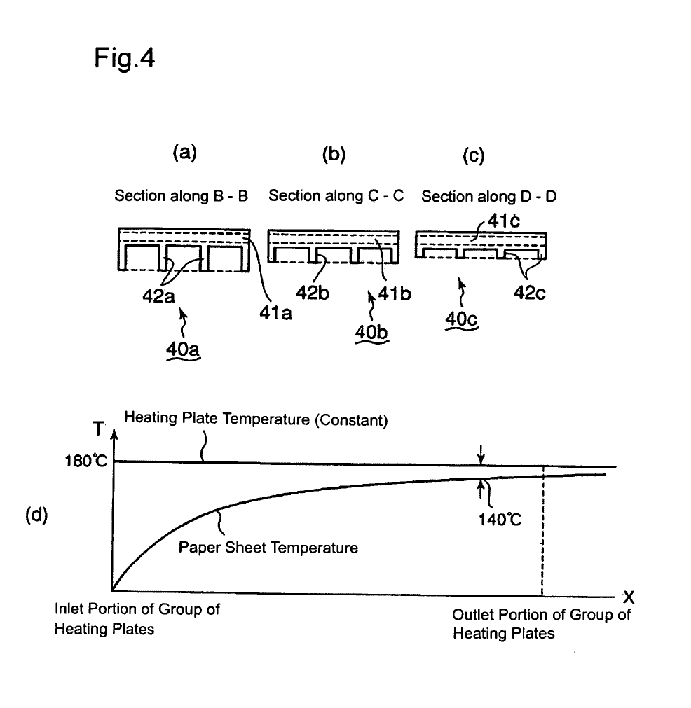

Next, explanation will be made of FIGS. 3 and 4 in a third embodiment of the present invention. FIG. 3 is a configuration view which shows a double facer body in this embodiment, (a) in FIG. 4 is a sectional view along line B-B in FIG. 4, (b) is a sectional view along line C-C in FIG. 3, (c) is a sectional view along line D-D in FIG. 3 and (d) is a chart which shows a temperature curve of the heating plate from the inlet portion to the outlet portion thereof and a temperature curve of the paper sheet.

Referring to FIG. 3, the heating plates 40 in this embodiment are those each having reinforcing ribs in a grid-like arrangement similar to the first embodiment. Referring to FIGS. 4(a) to 4(c), there are arranged three kinds of heating plates 40a, 40b and 40c having reinforcing ribs whose lengths are successively shorter and shorter, from the inlet portion to the outlet portion of the double facer. That is, the heating plate 40a incorporating reinforcing ribs 42a having a highest projection height is arranged in the inlet portion of a double facer 10, the heating plate 40b incorporating reinforcing ribs 42b having an intermediate projection height is arranged downstream of the heating plate 40a in the direction a of travel of the paper sheet, and the heating plate 40c incorporating reinforcing ribs 42c having a lowest projection height is arranged downstream of the heating plate 40b in the direction a of travel of the paper sheet. It is noted that the heating plates have respectively several steam through-holes 41a, 41b and 41c formed in their thin plate parts in parallel in a direction widthwise of the paper sheet.

Each of the heating plates is fed with saturated steam having one and the same pressure and one and the same temperature (normally 1.0 to 1.3 MPa, and 180 to 190 deg.C). Accordingly, as shown in FIG. 4(d), the heating temperature of the heating plate is constant from the inlet portion to the outlet portion thereof. Meanwhile, the paper sheet is gradually heated from the inlet portion to the outlet portion of the heating plate so as to increase the temperature thereof. The higher the temperature difference between the heating plate and the paper sheet, the larger the value of heat radiation fed to the paper sheet from the upper surface of the heating plate, and accordingly, the nearer the position with respect to the inlet portion of the heating plate, the larger the value of heat radiation from the heating plate to the paper sheet.

Thus, in this embodiment, in order to balance the value of heat radiation between the upper and lower surfaces of the heating plate, the projection height of the reinforcing ribs 42a of the heating plate 40a is set to be higher than other reinforcing ribs so as to increase the area of heat radiation, thereby it is possible to increase the value of heat radiation from the lower surface of the heating plate. It is noted, as shown in FIG. 4(d), that the temperature of the paper sheet in the outlet portion where the heating plate 40c is located reaches about 140 deg.C.

Thus, in this embodiment, the heating plates are arranged, the nearer the heating plate with respect to the inlet portion of the double facer, the higher the projection height of the reinforcing ribs 42, that is, the heating plates 40b, 40c are arranged, with the reinforcing ribs having projection heights which are successively shorter (lower) toward the outlet portion of the double facer, and the value of heat radiation to the paper sheet from the upper surface of the heating plate can be balanced with the value of heat radiation from the lower surface of the heating plate. Thus, the temperature difference between the upper surface and the lower surface of the heating plate is decreased, thereby it is possible to prevent the heating plate from being thermally warped.

### Embodiment 4

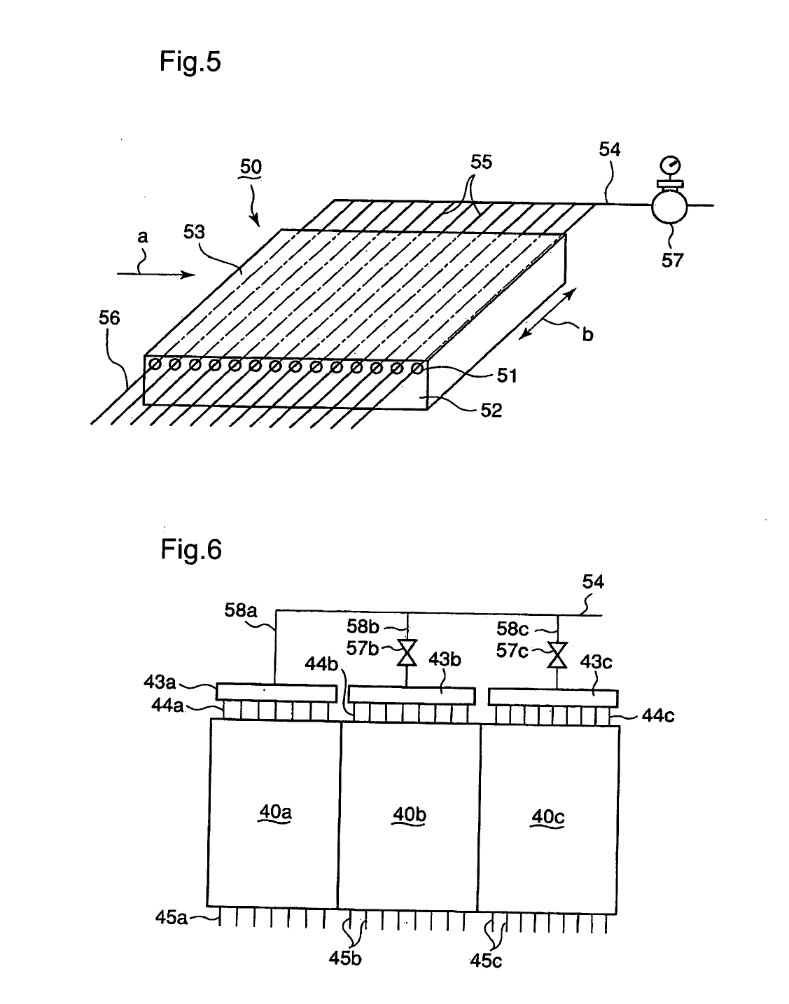

Next, explanation will be made of a fourth embodiment of the present invention with reference to FIG. 5 which is a perspective view illustrating a heating plate in this embodiment. Referring to FIG. 5, the configuration of the heating plate 50 in this embodiment is the same as that explained in the first embodiment, except that pressure reducing valves 57 are incorporated in a steam supply pipe line 54. That is, in this embodiment, the pressure of saturated steam fed from the steam supply pipe line 54 can be lowered by the pressure reducing valves 57 so as to feed the saturated steam having a desired pressure and a desired temperature corresponding to the desired pressure.

Thus, the saturated steam which is adjusted to have a desired temperature can be fed to each steam through-hole 51. For example, by introducing the saturated steam having a pressure of 1.25 MPa and a temperature of 190 deg.C fed from the steam supply pipe line into the pressure reducing valves 57, it is possible to feed the saturated steam having 0.36 MPa and 140 deg.C into the steam through-holes 51.

Thus, in this embodiment, with the simple configuration in which the pressure reducing valves 57 are incorporated in the steam supply pipe line 54, the saturated steam adjusted to have a desired temperature can be fed into the steam through-holes 51. Explanation will be made of a variant form in which this embodiment is applied in the third embodiment with referenced to FIG. 6. Referring to FIG. 6, the saturated steam fed from the steam supply pipe line 54 and having a pressure of 1.25 MPa and a temperature of 190 deg.C is fed into branch pipes 58a, 58b, 58c communicated respectively with the heating plates 40a, 40b, 40c. The branch pipes 58b, 58c are incorporated respectively with the pressure reducing valves 57b, 57c for changing the pressure of the saturated steam into different values in the branch pipes 58b, 58c, respectively.

Meanwhile, the saturated steam is fed without reducing the pressure through the branch pipe 58a in which no pressure reducing valves are incorporated. In the branch pipe 58b, the saturated steam is led through the pressure reducing valve 57b so as to change the pressure and the temperature of the saturated steam into 1.0 MPa and 180 deg.C. In the branch pipe 58c incorporating the pressure reducing valve 57c, the pressure and the temperature of the saturated steam are changed into 0.36 MPa and 140 deg.C. Thereafter, saturated steam having pressures and temperatures that are different from one another can be fed respectively into the heating plates 40a, 40b and 40c by way of headers 43a, 43b and 43c and branch pipes 44a, 44b and 44c. The steam fed into the heating plates heats up the paper sheet, and thereafter, it is discharged from branch pipes 45a, 45b and 45c.

Thus, the pressures in the branch pipes 44 are successively reduced for every one of the heating plates 40a, 40b and 40c that are arranged in parallel. Accordingly, there may be provided the temperature gradient that the temperature of the saturated steam is lowered, from the inlet portion to the outlet portion of the double facer. As a result, the temperature of the group of the heating plates can be set to a temperature curve as shown in FIG. 4(d), that is, it is not constant but has the temperature gradient in which the temperature is decreased to the outlet portion of the group of the heating plates from the inlet portion of the group of the heating plates where it is the highest.

With this temperature gradient, the paper sheet is heated at a high temperature in the inlet portion of the heating plate, and accordingly, the gelatinization of the glue can be promoted so as to exhibit satisfactory gluing. It is noted that not only supplying the saturated steam to the heating plate 50 respectively with different pressures but also changing the height of the reinforcing ribs 42a, 42b, 42c in accordance with the temperature gradient is preferable in order to obtain the temperature curve having the temperature gradient in which the temperature is decreased, to the outlet portion of the group of the heating plates, in the direction a of travel of the paper sheet from the inlet portion of the group of the heating plates where the temperature of saturated steam is highest, as shown in FIG. 4(d).

### Embodiment 5

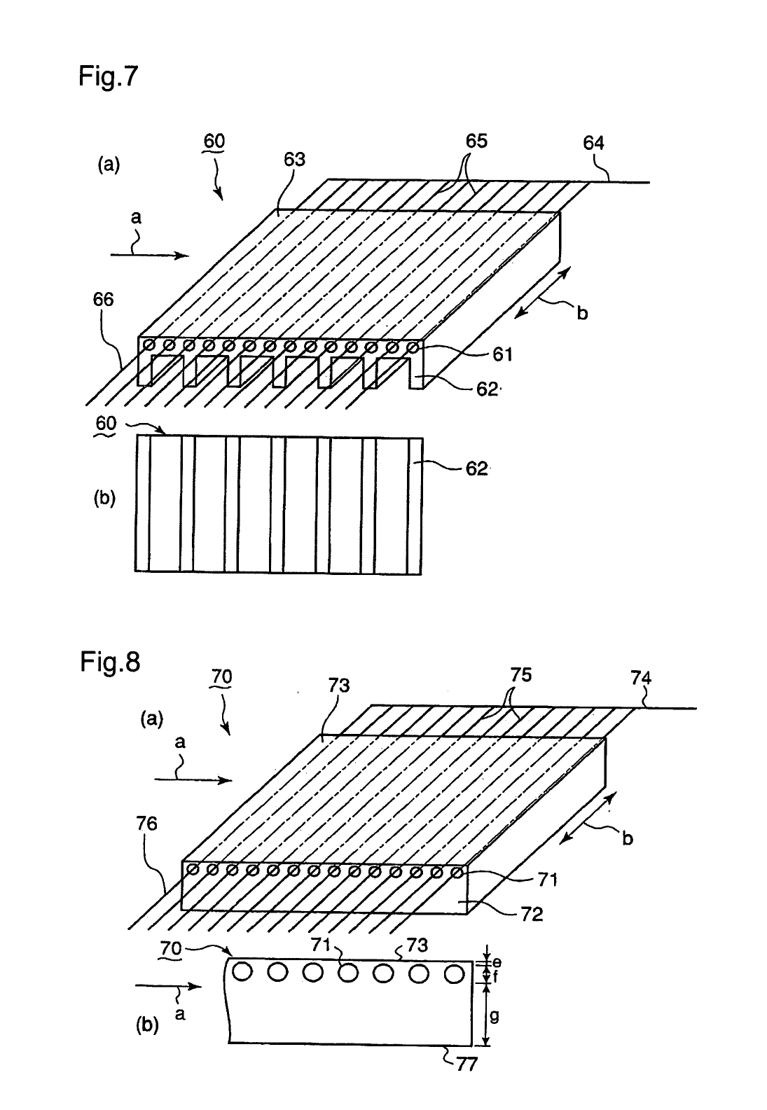

Next, explanation will be made of a fifth embodiment of the present invention with reference to FIG. 7 which shows a heating plate in this embodiment, and in which (a) is a perspective view and (b) is a bottom view. Referring to FIG. 7, the heating plate 60 in this embodiment has the same configuration as that of the first embodiment, except that reinforcing ribs 62 are arranged in parallel in the direction b widthwise of the paper sheet, being spaced from one another.

In this embodiment in which the reinforcing ribs 62 are arranged in the widthwise direction b of the paper sheet, being spaced from one another, the value of heat radiation from the lower surface of the heating plate can be balanced with the value of heat radiation from the upper surface of the heating plate, by means of the reinforcing ribs 62, thereby it is possible to prevent the heating plate 60 from warping. Further, since the reinforcing ribs 62 are laid in the widthwise direction b of the paper sheet, the heating plate 60 can be prevented by means of the reinforcing ribs 62 from warping in the widthwise direction b of the paper sheet. Further, the configuration of the reinforcing ribs can be simplified in comparison with that of the reinforcing ribs in the first embodiment, thereby it is possible to reduce the costs required for machining, welding and the like during the manufacture thereof. This embodiment can be applied to the production of a corrugated board with negligibly small warping, in the direction a of travel of a paper sheet.

### Embodiment 6

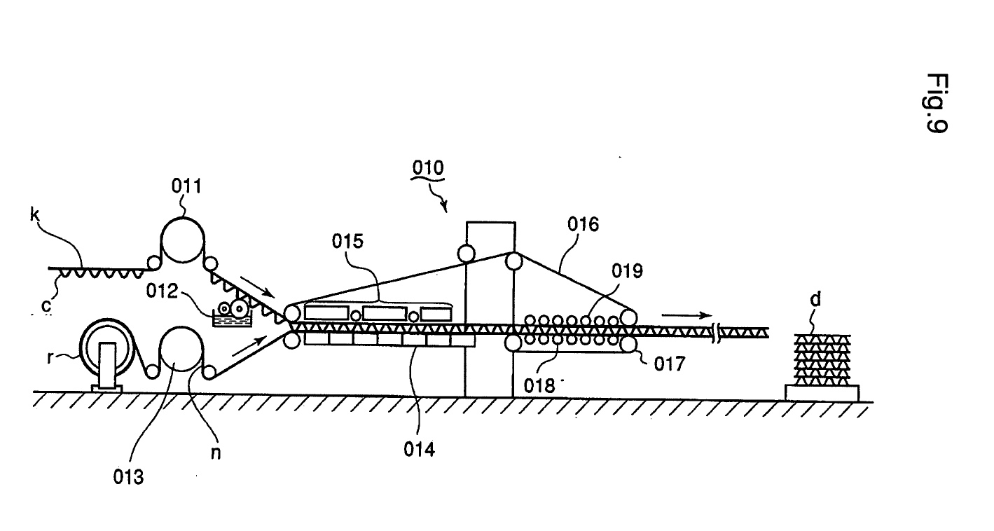

Next, explanation will be made of a sixth embodiment of the present invention with reference to FIG. 8 which shows a heating plate in this embodiment, and in which (a) is a perspective view and (b) is a partly enlarged elevation view. Referring to FIG. 8, no reinforcing ribs are formed while the heating plate 70 has a thick plate-like shape. Further, the wall thickness g measured from a bottom of steam through-holes 71 to a lower surface 77 of the heating plate 70 is set to be greater than that the wall thickness e measured from a top of the steam through-holes 71 to the upper surface 73 of the heating plate in order to balance the value of heat radiation from an upper surface 73 of the heating plate 70 due to the contact of the paper sheet thereto, with the value of heat radiation from the lower surface 77 of the heating plate due to the convective heat transfer thereat.

The wall thickness e measured from the top of the steam through-holes 71 to the upper surface 73 of the heating plate, the bore diameter f of the steam through-holes 71, and the wall thickness g measured from the bottom the steam through-holes 71 to the lower surface 77 of the heating plate are varied depending upon a travel speed and a kind of a paper sheet on the upper surface 73 of the heating plate. These dimensions are set, for example, as follows: e=10 mm, f=30 to 50 mm and g=80 to 200 mm.

According to this embodiment, the temperature difference between the upper and lower surfaces of the heating plate 70 can be decreased during the travel of the paper sheet, and accordingly, it is possible to reduce the degree of thermal deformation of the heating plate 70 caused by the temperature difference. Further, since the heating plate 70 is formed only of a thick plate without forming the reinforcing ribs for restraining thermal deformation, as stated in the afore-mentioned embodiments, the machining of the heating plate 70 can be simplified.

### INDUSTRIAL APPLICABILITY

According to the present invention, there is provided a double facer for manufacturing a corrugated board, in which a heating plate is made to be compact while the efficiency of heat transfer to a paper sheet which travels on an upper surface of the heating plate is enhanced, and the temperature difference between the upper surface and a lower surface of the heating plate is decreased. Thus, the thermal deformation of the heating plate is restrained within a tolerance so as to prevent the corrugated board from vertically warping caused by thermal deformation of the heating plate, thereby it is possible to aim at enhancing the quality of the corrugated board.

FIG. 1: SECTION ALONG A-A

FIG. 2: (T) . . . PAPER SHEET TEMPERATURE, [symbol] INLET PORTION OF HEATING PLATE, [symbol] OUTLET PORTION OF HEATING PLATE, C . . . INITIAL TEMPERATURE INCREASING GRADIENT FIG. 4: (a) . . . SECTION ALONG LINE B-B, (b) . . . SECTION ALONG LINE C-C, (c) . . . SECTION ALONG LINE D-D, (d), [symbol] INLET PORTION OF GROUP OF HEATING PLATES, [symbol] OUTLET PORTION OF GROUP OF HEATING PLATES, [symbol] PAPER SHEET TEMPERATURE, [symbol] ( [symbol] HEATING PLATE TEMPERATURE (CONSTANT)

1. A method of heating a double facer for gluing a one-sided corrugated board and a liner sheet which are web-like and which are superposed with each other while they travel on a heating plate so as to produce a corrugated board, characterized in that the heating plate is provided at a lower surface thereof with a heat radiation means so as to balance a value of heat radiation from an upper surface of the heating plate to the one-sided corrugated board and the liner sheet, with a value of heat radiation from the lower surface of the heating plate in order to restrain warping of the heating plate within a tolerance.

2. A method of heating a double facer as set forth in claim 1, characterized in that the value of heat radiation from the lower surface of the heating plate has a gradient with which the value of heat radiation is continuously or successively decreased from an inlet portion to an outlet portion of the heating plate in accordance with the value of heat radiation from the upper surface of the heating plate having a gradient with which the value of heat radiation is reduced from the inlet portion to the outlet portion of the heating plate.

3. A method of heating a double facer as set forth in claim 2, characterized in that the heating plate is formed in a planer shape, and is formed with several steam through-holes in parallel in a direction crossing a direction of travel of a paper sheet, preferably orthogonal to the direction of travel of a paper sheet, and saturated steam is fed into the steam through-holes from a steam supply pipe line by way of pressure reducing valves, the pressure of the saturated steam being lowered continuously or successively from the inlet portion to the outlet portion of the heating plate in order to decrease the temperature of the saturated steam from the inlet portion to the outlet portion of the heating plate.

4. A double facer for gluing a one-sided corrugated board and a liner sheet which are web-like and which are superposed with each other, while they travel on a heating plate so as to produce a corrugated board, characterized in that the heating plate is formed in a planar shape and is formed therein with several steam through-holes in parallel, in a direction crossing a direction of travel of a paper sheet, preferably orthogonal to the direction of travel of a paper sheet, and the heating plate is provided at its lower surface with heat radiation means having reinforcing ribs projected therefrom, for enlarging the area of heat radiation in order to balance the value of heat radiation from the upper surface of the heating plate to the one-sided corrugated board and the liner sheet with the value of heat radiation from the lower surface of the heating plate.

5. A double facer as set forth in claim 4, characterized in that the several reinforcing ribs are formed in parallel in the direction of travel of a paper sheet and in the direction crossing the direction of travel of a paper sheet, being spaced from one another so as to obtain a grid-like or rhombic combination.

6. A double facer as set forth in claim 4, characterized in that the several reinforcing ribs which are extended in the direction crossing the direction of travel of a paper sheet are arranged in parallel, being spaced from one another.

7. A double facer as set forth in claim 4, characterized in that a projection height of the reinforcing ribs is gradually decreased, from an inlet portion to an outlet portion of the heating plate.

8. A double facer as set forth in claim 4, characterized in that the steam through-holes are fed with saturated steam from a steam supply pipe line via pressure reducing valves, the pressure of the saturated steam having a gradient with which the pressure of the saturated steam is decreased step-likely or continuously from the inlet portion to the outlet portion of the heating plate, and accordingly the temperature of the saturated steam is lowered from the inlet portion to the outlet portion of the heating plate.

9. A double facer as set forth in claim 4, characterized in that the steam-though holes are connected in parallel to a steam supply pipe line so as to feed steam into the steam through-holes in one and the same direction.

10. A double facer as set forth in claim 4, characterized in that a steam supply pipe line is connected to the most upstream one of the steam through-holes of the heating plate in the direction of travel of a paper sheet, and the steam through-holes are connected with one another in series by communication pipes outside of the heating plate.

11. A double facer for gluing a one-sided corrugated board and a liner sheet which are web-like and which are superposed with one another so as to produce a corrugated board while the one-sided corrugated board and the liner sheet travels on a heating plate, characterized in that the heating plate is formed in a planar shape, and is formed in several steam through-holes in parallel in a direction crossing the direction of travel of a paper sheet, the wall thickness of the heating plate on the lower side of the steam through-holes is set to be larger than the wall thickness of the heating plate on the lower side of the steam through-holes in order to balance the value of heat radiation from the upper surface of the heating plate to the one-sided corrugated board and the liner sheet, with the value of heat radiation from the lower surface of the heating plate.

12. A double facer as set forth in claim 8, characterized in that the steam-though holes are connected in parallel to a steam supply pipe line so as to feed steam into the steam through-holes in one and the same direction.
